(19) United States
(12) Patent Application Publication
(10) Pub. No.: US 2016/0124826 A1
(43) Pub. Date: May 5, 2016

(54) SEMICONDUCTOR DEVICE AND METHOD FOR TESTING RELIABILITY OF SEMICONDUCTOR DEVICE

(71) Applicant: MegaChips Corporation, Osaka-shi (JP)

(72) Inventor: Takahiko SUGAHARA, Osaka-shi (JP)

(73) Assignee: MegaChips Corporation, Osaka-shi (JP)

(21) Appl. No.: 14/923,713

(22) Filed: Oct. 27, 2015

(30) Foreign Application Priority Data
Oct. 31, 2014 (JP) 2014-222151

(51) Int. Cl. G06F 11/27; G06F 11/22

(52) U.S. Cl. CPC G06F 11/27; G06F 11/2205

(57) ABSTRACT

A semiconductor memory includes a memory controller including a plurality of processing circuits. The plurality of processing units includes an encryption/decryption unit that encrypts and decrypts a signal transmitted to and from the memory controller. The encryption/decryption unit includes a self test unit that performs a reliability test of the encryption/decryption unit on receipt of a predetermined test command from a testing device.

### CROSS REFERENCE TO RELATED APPLICATIONS

The present application is based on, and claims priority from Japanese Patent Application Serial Number 2014-222151, the disclosure of which is hereby incorporated by reference herein in its entirety.

### BACKGROUND

1. Technical Field

The present disclosure relates to semiconductor devices such as a semiconductor memory, and methods for testing reliability of semiconductor devices.

2. Related Art

One of known examples of Design For Testability (DFT) of LSI is a scan test.

In the scan test, a scan circuit is provided in a target circuit. In a test mode for performing a test, flip-flops in the scan circuit are connected in serial to form a scan path. Then a test signal is input from a scan-in terminal and the test signal output from a scan-out terminal via the scan path is detected, so as to observe the operation of the circuit. Failures in the circuit such as stuck-at fault are thereby searched automatically.

Yuma ITO et al. in “An evaluation of encryption LSI testability against scan based attack”, IEICE technical report, The Institute of Electronics, Information and Communication Engineers, Feb. 8, 2008, No. 107(482), pp. 57-62 describe one example of scan test techniques for encryption LSI using Data Encryption Standard (DES).

### SUMMARY

A semiconductor device according to an aspect of the present disclosure includes a controller including a plurality of processing circuits. The plurality of processing circuits includes an encryption/decryption circuit configured to encrypt and decrypt a signal transmitted to and from the controller. The encryption/decryption circuit includes a self test circuit configured to perform a reliability test of the encryption/decryption circuit on receipt of a predetermined test command from an external device.

A method for testing reliability of a semiconductor device according to another aspect of the present disclosure is a method for testing reliability of a semiconductor device including a plurality of processing circuits including an encryption/decryption circuit. The method includes performing a reliability test of the encryption/decryption circuit by a self test, and performing a reliability test of the plurality of processing circuits except for the encryption/decryption circuit by a scan test.

These and other objects, features, aspects and advantages of the present disclosure will become more apparent from the following detailed description when taken in conjunction with the accompanying drawings.

### BRIEF DESCRIPTION OF THE DRAWINGS

FIG. 1 is a diagram illustrating a reliability test on a semiconductor memory according to some embodiments of the present disclosure.

FIG. 2 is a diagram illustrating a configuration of the semiconductor memory.

FIG. 3 is a diagram illustrating a configuration of a memory controller.

FIG. 4 is a diagram illustrating a configuration of an encryption/decryption unit according to Embodiment 1 of the present disclosure.

FIG. 5 is a diagram illustrating a test command sent from a testing device to the semiconductor memory.

FIG. 6 is a diagram illustrating a configuration of the encryption/decryption unit according to Embodiment 2 of the present disclosure.

FIG. 7 is a diagram illustrating a test command sent from the testing device to the semiconductor memory.

FIG. 8 is a diagram illustrating a configuration of the encryption/decryption unit according to Embodiment 3 of the present disclosure.

FIG. 9 a diagram illustrating a test command sent from the testing device to the semiconductor memory.

FIG. 10 is a diagram illustrating a configuration of the encryption/decryption unit according to Embodiment 4 of the present disclosure.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

Semiconductor memories such as a memory card are generally provided with a cryptographic module for encrypting communication data between the semiconductor memory and a host device, in order to protect content data stored in a memory array. In cryptographic modules, data is mixed by non-linear properties of a cryptographic algorithm. Thus in checking intermittent failures (such as current fluctuation noise dependent on data) by a scan test on a semiconductor memory provided with a cryptographic module, it is hard to produce a desired test pattern in consideration of data mixing in a cryptographic module, which results in increase in test patterns and testing cost.

Moreover, providing a cryptographic module, which is a logic section responsible for a security feature, with a scan circuit may allow a third party to abuse the test mode to draw out secret information such as common keys by a so-called scan-based attack through a scan path.

In order to avoid scan-based attacks, the scan test is occasionally performed with cryptographic modules excluded from the test. On such occasions, since the reliability test of the cryptographic modules is not performed, the semiconductor memory lacks testability as a whole and thus decreases in reliability.

The present disclosure is directed to obtaining a semiconductor device provided with security features by encryption of communication data and a method for testing the reliability thereof that improves security, testability, and reliability, while reducing testing costs.

According to an aspect of the semiconductor device of the present disclosure, an encryption/decryption circuit includes a self test circuit. The self test circuit performs a reliability test of the encryption/decryption circuit on receipt of a predetermined test command from an external device. The encryption/decryption circuit responsible for a security feature in the semiconductor device is not provided with a scan circuit, but with the self test circuit for the Built-In Self Test (BIST). Producing a desired test pattern for check for failures such as an intermittent failure is therefore facilitated, and thus testing cost is reduced. Moreover, since the encryption/decryption circuit is not provided with a scan circuit, a scan-based attack by a third party is avoided, and thus security is improved. Furthermore, without excluding the encryption/decryption circuit from the test, an efficient reliability test is performed on the encryption/decryption circuit by the self test circuit, which improves testability and reliability of the semiconductor device as a whole.

In some embodiments, the encryption/decryption circuit further includes a first data generation circuit configured to generate first data, and a second data generation circuit configured to generate second data for encryption and decryption based on the first data generated by the first data generation circuit. The self test circuit is configured to perform a reliability test of the first data generation circuit and the second data generation circuit based on the second data generated by the second data generation circuit.

According to such embodiments, the self test circuit performs a reliability test of the first data generation circuit and the second data generation circuit based on the second data generated by the second data generation circuit. Performing the test of the first data generation circuit and the second data generation circuit together achieves lower cost as a result of a reduced circuit size, than performing the tests of these circuits separately.

In some embodiments, the self test circuit includes an extraction circuit configured to extract an expected value from the test command, a storage for storing the expected value extracted by the extraction circuit, an arithmetic circuit configured to perform a predetermined arithmetic operation on the second data generated by the second data generation circuit and output an arithmetic value, and a comparison circuit configured to compare the arithmetic value output from the arithmetic circuit with the expected value stored in the storage. The self test circuit is configured to send a result of comparison by the comparison circuit to the external device.

According to such embodiments, the extraction circuit extracts an expected value from the test command, the storage stores the expected value extracted from the extraction circuit, and the arithmetic circuit performs a predetermined arithmetic operation on the second data generated by the second data generation circuit and outputs an arithmetic value. The comparison circuit compares the arithmetic value output from the arithmetic circuit with the expected value stored in the storage, and a result of comparison by the comparison circuit is sent to the external device. Comparing the expected value and the arithmetic value by the comparison circuit in the semiconductor device achieves an appropriate check on the first and the second data generation circuits for a failure. Since it is not necessary to send the arithmetic value from the semiconductor device to the external device, the amount of communication data between these devices is effectively reduced.

In some embodiments, the self test circuit includes an arithmetic circuit configured to perform a predetermined arithmetic operation on the second data generated by the second data generation circuit. The self test circuit is configured to send an arithmetic value output from the arithmetic circuit to the external device.

According to such embodiments, the arithmetic circuit performs a predetermined arithmetic operation on the second data generated by the second data generation circuit. The arithmetic value output from the arithmetic circuit is sent to the external device. Comparing the expected value and the received arithmetic value by the external device achieves an appropriate check on the first and the second data generation circuits for a failure. Since it is not necessary to provide the semiconductor device with the storage and the comparison circuit, the configuration of the semiconductor device is effectively simplified.

In some embodiments, the self test circuit is configured to input the second data generated by the second data generation circuit to the first data generation circuit to cause the first data generation circuit and the second data generation circuit generate subsequent first data and subsequent second data respectively so as to perform the reliability test of the first data generation circuit and the second data generation circuit a plurality of times.

According to such embodiments, the self test circuit inputs the second data generated by the second data generation circuit to the first data generation circuit to cause the first data generation circuit and the second data generation circuit to generate subsequent first data and subsequent second data respectively so as to perform the reliability test of the first data generation circuit and the second data generation circuit a plurality of times. Performing the reliability test of the first data generation circuit and the second data generation circuit a plurality of times improves the precision of the test. A test pattern is updated by inputting the second data generated by the second data generation circuit to the first data generation circuit, which facilitates producing a plurality of test patterns by the encryption/decryption circuit itself.

In some embodiments, a number of counts to perform the reliability test of the first data generation circuit and the second data generation circuit is specified by the test command.

According to such embodiments, the number of counts to perform the reliability test of the first data generation circuit and the second data generation circuit is specified by the test command. Specifying the number of counts to perform the reliability test by the external device effectively optimizes the number of counts to perform the test depending on required precision of the test.

In some embodiments, the encryption/decryption circuit further includes a first data generation circuit configured to generate first data, and a second data generation circuit configured to generate second data for encryption and decryption based on the first data generated by the first data generation circuit. The self test circuit is configured to perform the reliability test of the first data generation circuit based on the first data generated by the first data generation circuit and perform the reliability test of the second data generation circuit based on the second data generated by the second data generation circuit.

According to such embodiments, the self test circuit performs the reliability test of the first data generation circuit based on the first data generated by the first data generation circuit, and performs the reliability test of the second data generation circuit based on the second data generated by the second data generation circuit. Performing the tests of the first data generation circuit and the second data generation circuit separately achieves accurate identification as to whether a failure occurs in the first data generation circuit or the second data generation circuit.

In some embodiments, the self test circuit includes an extraction circuit configured to extract a first expected value and a second expected value from the test command, a first storage for storing the first expected value extracted by the extraction circuit, a second storage for storing the second expected value extracted by the extraction circuit, a first arithmetic circuit configured to perform a predetermined arithmetic operation on the first data generated by the first data generation circuit and output a first arithmetic value, a first comparison circuit configured to compare the first arithmetic value output from the first arithmetic circuit with the first expected value stored in the first storage, a second arithmetic circuit configured to perform a predetermined arithmetic operation on the second data generated by the second data generation circuit and output a second arithmetic value, and a second comparison circuit configured to compare the second arithmetic value output from the second arithmetic circuit with the second expected value stored in the second storage. The self test circuit is configured to send a result of comparison by the first comparison circuit and a result of comparison by the second comparison circuit to the external device.

According to such embodiments, the extraction circuit extracts a first expected value and a second expected value from the test command. The first storage stores the first expected value extracted by the extraction circuit. The second storage stores the second expected value extracted by the extraction circuit. The first arithmetic circuit performs a predetermined arithmetic operation on the first data generated by the first data generation circuit and outputs a first arithmetic value. The second arithmetic circuit performs a predetermined arithmetic operation on the second data generated by the second data generation circuit and outputs a second arithmetic value. The first comparison circuit compares the first arithmetic value output from the first arithmetic circuit with the first expected value stored in the first storage. The second comparison circuit compares the second arithmetic value output from the second arithmetic circuit with the second expected value stored in the second storage. The result of comparison by the first comparison circuit and the second comparison circuit is sent to the external device. Comparing the first expected value and the first arithmetic value by the first comparison circuit in the semiconductor device achieves an appropriate check on the first data generation circuit for a failure. Similarly, comparing the second expected value and the second arithmetic value by the second comparison circuit in the semiconductor device achieves an appropriate check on the second data generation circuit for a failure. Since it is not necessary to send the first arithmetic value and the second arithmetic value from the semiconductor device to the external device, the amount of communication data between these devices is effectively reduced.

In some embodiments, the self test circuit includes a first arithmetic circuit configured to perform a predetermined arithmetic operation on the first data generated by the first data generation circuit, and a second arithmetic circuit configured to perform a predetermined arithmetic operation on the second data generated by the second data generation circuit. The self test circuit is configured to send the first arithmetic value output from the first arithmetic circuit and the second arithmetic value output from the second arithmetic circuit to the external device.

According to such embodiments, the first arithmetic circuit performs a predetermined arithmetic operation on the first data generated by the first data generation circuit. The second arithmetic circuit performs a predetermined arithmetic operation on the second data generated by the second data generation circuit. The first arithmetic value output from the first arithmetic circuit and the second arithmetic value output from the second arithmetic circuit are sent to the external device. Comparing the expected value and the received first arithmetic value by the external device achieves an appropriate check on the first data generation circuit for a failure. Similarly, comparing the expected value and the received second arithmetic value by the external device achieves an appropriate check on the second data generation circuit for a failure. Since it is not necessary to provide the semiconductor device with the storage and the comparison circuit, the configuration of the semiconductor device is effectively simplified.

In some embodiments, the self test circuit is configured to input the first data generated by the first data generation circuit to the first data generation circuit to cause the first data generation circuit to generate subsequent first data so as to perform the reliability test of the first data generation circuit a plurality of times, and input the second data generated by the second data generation circuit to the second data generation circuit to cause the second data generation circuit to generate subsequent second data so as to perform the reliability test of the second data generation circuit a plurality of times.

According to such embodiments, the self test circuit inputs the first data generated by the first data generation circuit to the first data generation circuit to cause the first data generation circuit to generate subsequent first data so as to perform the reliability test of the first data generation circuit a plurality of times. Similarly, the self test circuit inputs the second data generated by the second data generation circuit to the second data generation circuit to cause the second data generation circuit to generate subsequent second data so as to perform the reliability test of the second data generation circuit a plurality of times. Performing the reliability test of the first data generation circuit and the second data generation circuit a plurality of times improves the precision of the test. A test pattern is updated by inputting the first data generated by the first data generation circuit to the first data generation circuit and inputting the second data generated by the second data generation circuit to the second data generation circuit, which facilitates producing a plurality of test patterns by the encryption/decryption circuit itself.

In some embodiments, a number of counts to perform the reliability test of the first data generation circuit and the second data generation circuit is specified by the test command.

According to such embodiments, the number of counts to perform the reliability test of the first data generation circuit and the second data generation circuit is specified by the test command. Specifying the number of counts to perform the reliability test by the external device effectively optimizes the number of counts to perform the test depending on required precision of the test.

According to another aspect of the present disclosure, the reliability test of the encryption/decryption circuit is performed by a self test. The encryption/decryption circuit responsible for in the semiconductor device is not provided with a scan circuit, and thus the reliability test is performed by a self test in by the Built-In Self Test (BIST). Producing a desired test pattern for check for failures such as an intermittent failure is therefore facilitated, and thus testing cost is reduced. Moreover, since the encryption/decryption circuit is not provided with a scan circuit, a scan-based attack by a third party is avoided, and thus security is improved. Furthermore, without excluding the encryption/decryption circuit from the test, an efficient reliability test is performed on the encryption/decryption circuit by the self test, which testability and reliability of the semiconductor device as a whole.

Embodiments of the present disclosure improves security, testability, and reliability of a semiconductor device provided with security feature by encryption of communication data, while reducing testing costs.

### DESCRIPTION OF EMBODIMENTS

Embodiments of the present disclosure are described in detail below referring to the drawings. It should be noted that identical reference numerals throughout the drawings indicate identical or equivalent elements.

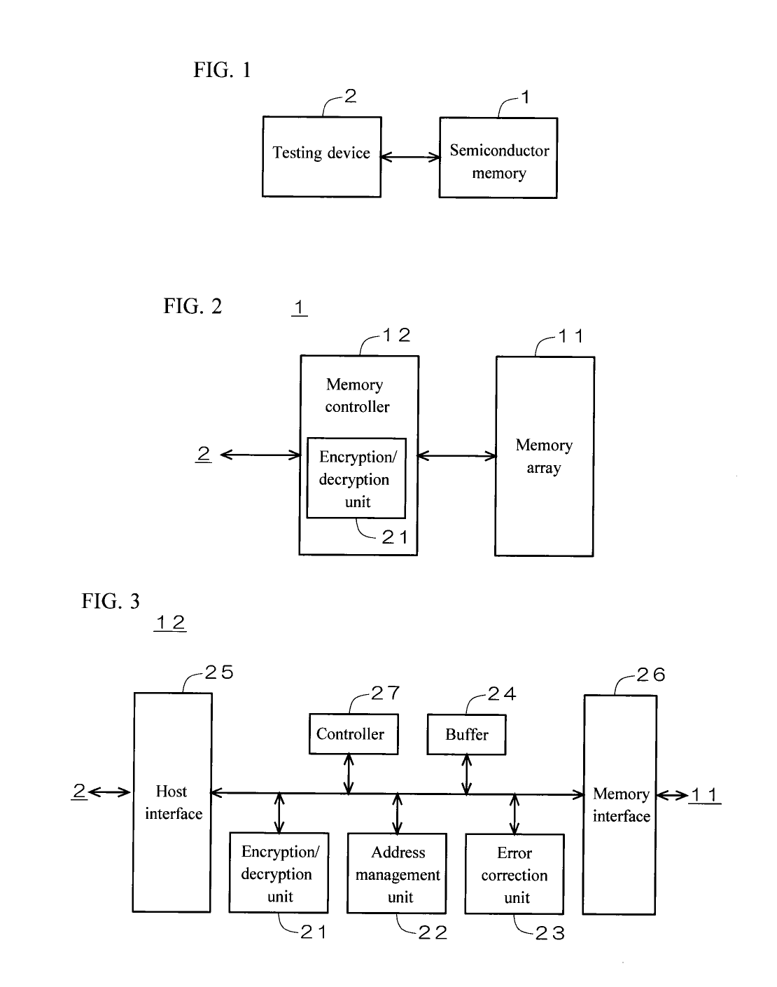

FIG. 1 is a diagram illustrating a reliability test on a semiconductor memory 1 according to some embodiments of the present disclosure. The semiconductor memory 1 is connected to a testing device 2, so as to perform a reliability test. Examples of the semiconductor memory 1 include a memory card detachably connectable to a host device. Alternatively, an arbitrary memory device such as an optical disc or a magnetic disk can replace the memory card. In place of the testing device 2, an arbitrary external device such as a simple tester or a host device having a test function may be employed to perform the reliability test of the semiconductor memory 1.

FIG. 2 is a diagram illustrating a configuration of the semiconductor memory 1. The semiconductor memory 1 includes a memory array 11 for storing content data and a memory controller 12 connected to the memory array 11. The memory array 11 includes a NAND type flash memory.

FIG. 3 is a diagram illustrating a configuration of the memory controller 12. The memory controller 12 includes multiple processing units, each of which may comprise suitable logic, circuitry, interfaces and/or code. The processing units include an encryption/decryption unit 21, an address management unit 22, an error correction unit 23, a buffer 24, a host interface 25, a memory interface 26, and a controller 27.

The encryption/decryption unit 21 encrypts communication data between the semiconductor memory 1 and the host device to protect content data stored in the memory array 11. The example of the present embodiment employs stream encryption that performs encryption with a stream data (key stream) generated based on a common key for a cryptographic algorithm of the encryption/decryption unit 21.

The address management unit 22 performs processing such as translation between the logical address and the physical address and management of bad blocks. The error correction unit 23 performs processing such as judgment on presence or absence of bit errors in content data and correction of bit errors if any. The buffer 24 temporarily stores content data to be processed by the memory controller 12. The host interface 25 controls data communications between the memory controller 12 and the host device. The memory interface 26 controls data communications between the memory controller 12 and the memory array 11. The controller 27 is configured with a CPU or hardware sequencer and controls the operations of processing units in the memory controller 12.

The processing units in the memory controller 12 except for the encryption/decryption unit 21, that is, the address management unit 22, the error correction unit 23, the buffer 24, the host interface 25, the memory interface 26, and the controller 27, are each provided with a scan circuit (not illustrated in the figure) for the scan test. Thus the reliability test of these processing units except for the encryption/decryption unit 21 is performed by the scan test.

In contrast, since the encryption/decryption unit 21 is not provided with a scan circuit for the scan test, the reliability test of the encryption/decryption unit 21 is performed by a below-described self test.

### Embodiment 1

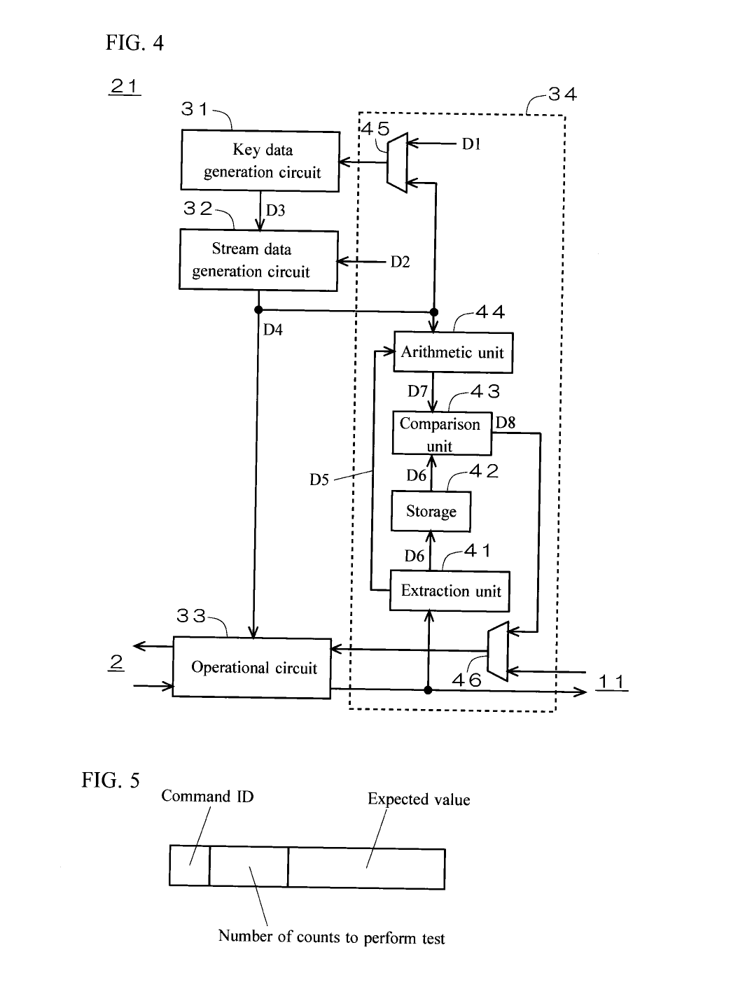

FIG. 4 is a diagram illustrating a configuration of the encryption/decryption unit 21 according to Embodiment 1 of the present disclosure. FIG. 4 illustrates connection in the encryption/decryption unit 21 between a key data generation circuit 31 (first data generation circuit) that generates key data (first data) on the basis of a common key that is secret information, a stream data generation circuit 32 (second data generation circuit) that generates stream data (second data) on the basis of the common key and the key data, an operational circuit 33 that performs encryption and decryption by an exclusive-OR operation with the stream data, and a self test unit 34 that may comprise suitable logic, circuitry, interfaces and/or code that may be operable to perform Built-In Self Test (BIST). The self test unit 34 performs a reliability test of the encryption/decryption unit 21 on receipt of a predetermined test command from the testing device 2. FIG. 4 illustrates connection in the self test unit 34 between an extraction unit 41, a storage 42, a comparison unit 43, an arithmetic unit 44, and selectors 45 and 46. The extraction unit 41, the comparison unit 43, and the arithmetic unit 44 may each comprise suitable logic, circuitry, interfaces and/or code.

FIG. 5 is a diagram illustrating a test command sent from the testing device 2 to the semiconductor memory 1. The test command contains a predetermined command ID indicating that it is a test command, a test count for specifying the number of counts to repeat the test, and an expected value of a test result in each test.

Description is given below of processing to perform the reliability test of the encryption/decryption unit 21.

The testing device 2 determines the number of counts to perform the test depending on required precision of the test. The count information for specifying the number of counts to perform the test may be stored in an arbitrary storage in the semiconductor memory 1 (such as the memory array 11, or a RAM, a ROM, or a register in the memory controller 12) in advance. The testing device 2 then receives the count information from the semiconductor memory 1 to determine the number of counts to perform the test.

The testing device 2 generates an expected value in each test. The testing device 2 is provided with the same test algorithm and common key as the encryption/decryption unit 21. The testing device 2 repeats the test algorithm for the number of counts to be performed as determined above, so as to generate an arithmetic value (CRC or hash value) as an expected value in each test.

The testing device 2 generates a test command (FIG. 5) containing a predetermined command ID and the above-obtained number of counts to perform the test and expected value in each test, and sends the test command to the semiconductor memory 1.

The semiconductor memory 1 receives the test command and inputs the test command to the encryption/decryption unit 21. Since the test command is not encrypted, the received test command passes through the operational circuit 33 and is input to the extraction unit 41. The encryption/decryption unit 21 enters the test mode on receipt of an input of the test command, and switches the input terminal of the selector 46 from the memory array 11 for the normal mode to the comparison unit 43 for the test mode.

The extraction unit 41 extracts the test count and the expected value from the test command, and inputs the test count as data D5 to the arithmetic unit 44 while storing the expected value as data D6 in the storage 42 such as a register. At this time, the input terminal of the selector 45 is set to the common key D1.

The key data generation circuit 31 generates key data D3 for the first test, on the basis of the common key D1 input from the selector 45.

The stream data generation circuit 32 generates stream data D4 for the first test, on the basis of the key data D3 input from the key data generation circuit 31.

The arithmetic unit 44 performs a predetermined arithmetic operation on the stream data D4 input from the stream data generation circuit 32 to calculate an arithmetic value (CRC or hash value) in the first test.

The comparison unit 43 compares the arithmetic value (data D7) input from the arithmetic unit 44 with the expected value (data D6) input from the storage 42 to judge whether the arithmetic value is in agreement with the expected value in the first test, and generates data D8 indicating a result of comparison.

The selector 45 switches the input terminal from the common key D1 to the stream data generation circuit 32 in order to perform the second test. The key data generation circuit 31 thereby receives an input of the stream data D4 for the first test. The key data generation circuit 31 generates the key data D3 for the second test, using the stream data D4 for the first test as a test pattern. In the third and onward tests, the input terminal of the selector 45 is similarly set to the stream data generation circuit 32.

From this point onward, processing similar to the above is repeated for the number of test counts, and the data D8 indicating the result of comparison in each test is output from the comparison unit 43.

The encryption/decryption unit 21 sends the data D8 for the specified number of test counts to the testing device 2 as a return value to the test command.

As described above, in the semiconductor memory (semiconductor device) 1 according to Embodiment 1, the encryption/decryption unit 21 includes the self test unit 34, and the self test unit 34 performs a reliability test of the encryption/decryption unit 21 on receipt of a predetermined test command from the testing device 2. In other words, the encryption/decryption unit 21 responsible for security feature in the semiconductor memory 1 is not provided with a scan circuit, but with the self test unit 34 for the BIST. Producing a desired test pattern for checking for failures such as an intermittent failure is therefore facilitated, and thus testing cost is reduced. Moreover, since the encryption/decryption unit 21 is not provided with a scan circuit, a scan-based attack by a third party is avoided, and thus security is improved. Furthermore, without excluding the encryption/decryption unit 21 from the test, an efficient reliability test is performed on the encryption/decryption unit 21 by the self test unit 34, which improves testability and reliability of the semiconductor memory 1 as a whole.

In the semiconductor memory 1 according to Embodiment 1, the self test unit 34 performs the reliability test of the key data generation circuit 31 and the stream data generation circuit 32, on the basis of the stream data D4 generated by the stream data generation circuit 32. Performing the test of the key data generation circuit 31 and the stream data generation circuit 32 together achieves lower cost as a result of a reduced circuit size, than performing the tests of these circuits separately.

In the semiconductor memory 1 according to Embodiment 1, the extraction unit 41 extracts the expected value from the test command, the storage 42 stores the expected value extracted by the extraction unit 41, and the arithmetic unit 44 performs a predetermined arithmetic operation on the stream data D4 generated by the stream data generation circuit 32 and outputs the arithmetic value. The comparison unit 43 compares the arithmetic value output from the arithmetic unit 44 with the expected value stored in the storage 42, and the result of comparison by the comparison unit 43 is sent to the testing device 2. Comparing the expected value and the arithmetic value by the comparison unit 43 in the semiconductor memory 1 achieves an appropriate check on the key data generation circuit 31 and the stream data generation circuit 32 for a failure. Since it is not necessary to send the arithmetic value from the semiconductor memory 1 to the testing device 2, the amount of communication data between these devices is effectively reduced.

In the semiconductor memory 1 according to Embodiment 1, the self test unit 34 inputs the stream data D4 generated by the stream data generation circuit 32 to the key data generation circuit 31, and causes the key data generation circuit 31 and the stream data generation circuit 32 to generate the subsequent key data D3 and subsequent stream data D4 respectively, so as to perform the reliability test of the key data generation circuit 31 and the stream data generation circuit 32 multiple times. Performing the reliability test of the key data generation circuit 31 and the stream data generation circuit 32 multiple times improves the precision of the test. A test pattern is updated by inputting the stream data D4 generated by the stream data generation circuit 32 to the key data generation circuit 31, which facilitates producing multiple test patterns by the encryption/decryption unit 21 itself.

In the semiconductor memory 1 according to Embodiment 1, the number of counts to perform the reliability test of the key data generation circuit 31 and the stream data generation circuit 32 is specified by means of a test command. Specifying the number of counts to perform the reliability test by the testing device 2 effectively optimizes the number of counts to perform the test depending on required precision of the test.

### Embodiment 2

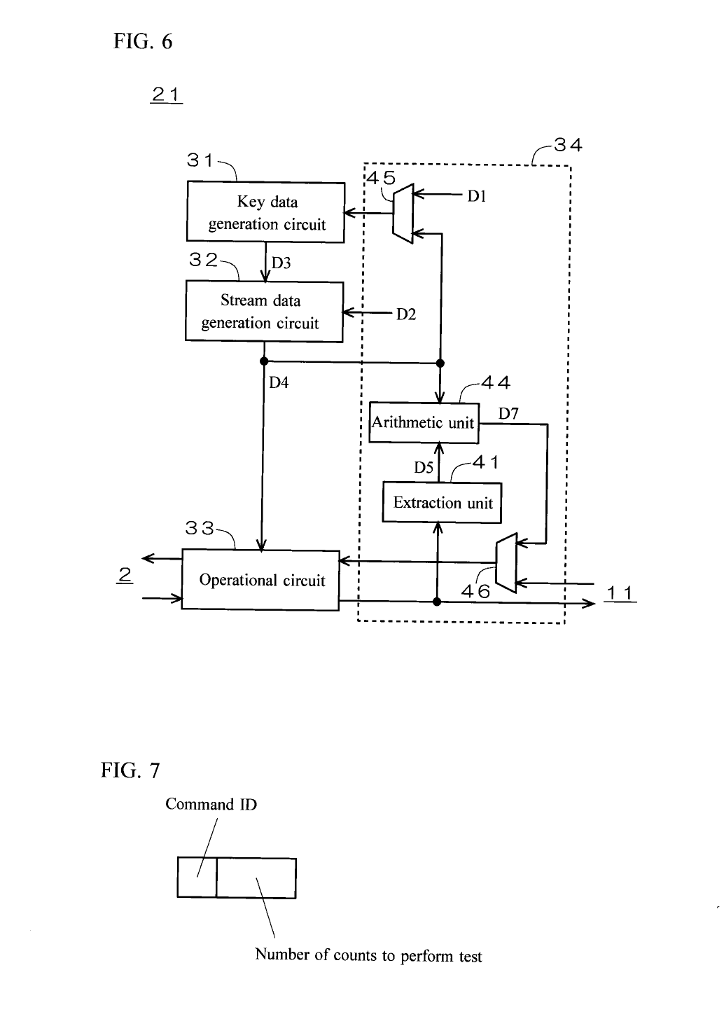

FIG. 6 is a diagram illustrating a configuration of the encryption/decryption unit 21 according to Embodiment 2 of the present disclosure. The storage 42 and the comparison unit 43 are omitted from the circuit configuration illustrated in FIG. 4.

FIG. 7 is a diagram illustrating a test command sent from the testing device 2 to the semiconductor memory 1. The expected value is omitted from the data structure illustrated in FIG. 5.

Description is given below of processing to perform the reliability test of the encryption/decryption unit 21, concentrating on differences from Embodiment 1 above.

The testing device 2 determines the number of counts to perform the test depending on required precision of the test.

The testing device 2 generates an expected value in each test.

The testing device 2 generates a test command (FIG. 7) containing a predetermined command ID and the above-obtained number of counts to perform the test, and sends the test command to the semiconductor memory 1. The testing device 2 stores the above-obtained expected value in each test in itself without sending the value to the semiconductor memory 1.

The semiconductor memory 1 receives the test command and inputs the test command to the encryption/decryption unit 21. The encryption/decryption unit 21 enters the test mode on receipt of an input of the test command, and switches the input terminal of the selector 46 from the memory array 11 for the normal mode to the arithmetic unit 44 for the test mode.

The extraction unit 41 extracts the test count from the test command, and inputs the test count as data D5 to the arithmetic unit 44. At this time, the input terminal of the selector 45 is set to the common key D1.

The key data generation circuit 31 generates key data D3 for the first test, on the basis of the common key D1 input from the selector 45.

The stream data generation circuit 32 generates stream data D4 for the first test, on the basis of the key data D3 input from the key data generation circuit 31.

The arithmetic unit 44 performs a predetermined arithmetic operation on the stream data D4 input from the stream data generation circuit 32 to calculate an arithmetic value in the first test.

The selector 45 switches the input terminal from the common key D1 to the stream data generation circuit 32 in order to perform the second test. The key data generation circuit 31 thereby receives an input of the stream data D4 for the first test. The key data generation circuit 31 generates the key data D3 for the second test, using the stream data D4 for the first test as a test pattern. In the third and onward tests, the input terminal of the selector 45 is similarly set to the stream data generation circuit 32.

From this point onward, processing similar to the above is repeated for the number of test counts, and the data D7 indicating the arithmetic value in each test is output from the arithmetic unit 44.

The encryption/decryption unit 21 sends the data D7 for the specified number of test counts to the testing device 2 as a return value to the test command.

The testing device 2 compares the arithmetic value (data D7) received from the semiconductor memory 1 with the expected value stored in itself for each test to judge whether the arithmetic value is in agreement with the expected value.

In the semiconductor memory 1 according to Embodiment 2, the arithmetic unit 44 performs a predetermined arithmetic operation on the stream data D4 generated by the stream data generation circuit 32, and the arithmetic value (data D7) output from the arithmetic unit 44 is sent to the testing device 2. Comparing the expected value and the arithmetic value by the testing device 2 achieves an appropriate check on the key data generation circuit 31 and the stream data generation circuit 32 for a failure. Since it is not necessary to provide the semiconductor memory 1 with the storage 42 and the comparison unit 43, the configuration of the semiconductor memory 1 is effectively simplified.

### Embodiment 3

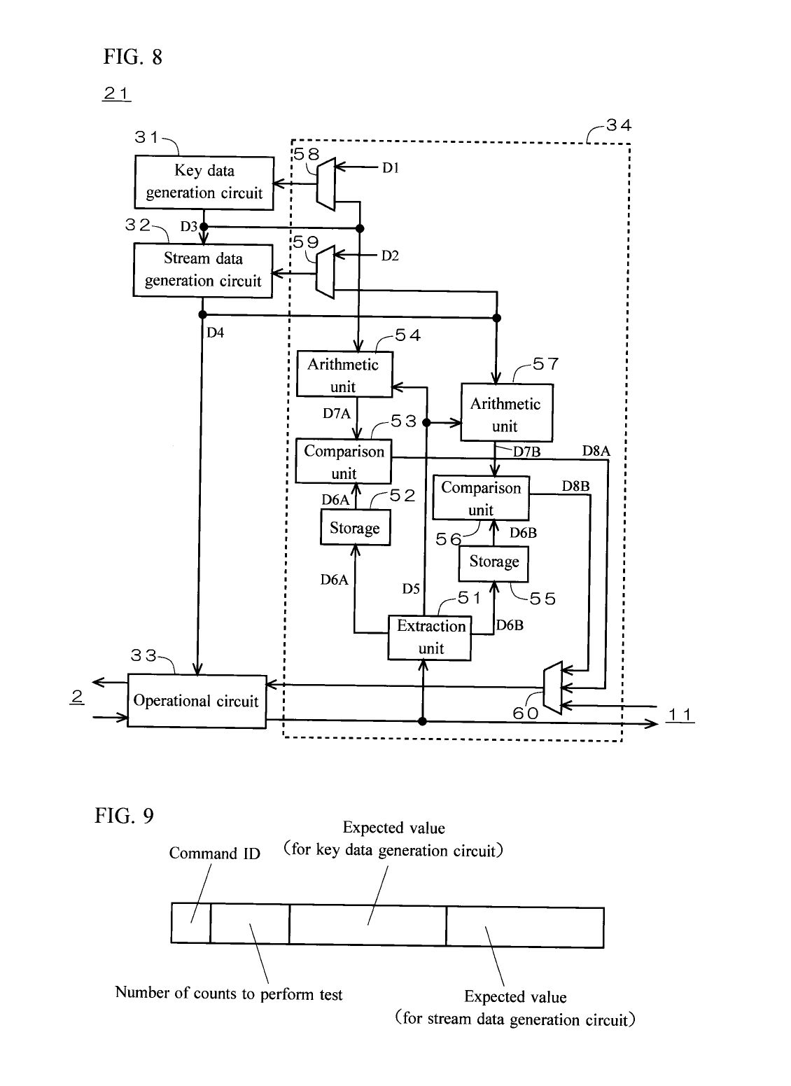

FIG. 8 is a diagram illustrating a configuration of the encryption/decryption unit 21 according to Embodiment 3 of the present disclosure. FIG. 8 illustrates connection in the self test unit 34 between an extraction unit 51, storages 52 and 55, comparison units 53 and 56, arithmetic units 54 and 57, and selectors 58 to 60. The extraction unit 51, the comparison units 53 and 56, and the arithmetic units 54 and 57 may each comprise suitable logic, circuitry, interfaces and/or code.

FIG. 9 is a diagram illustrating a test command sent from the testing device 2 to the semiconductor memory 1. The test command contains a predetermined command ID indicating that it is a test command, a test count for specifying the number of counts to repeat the test, and expected values (for a key data generation circuit and for a stream data generation circuit) of a test result in each test. Embodiment 3 employs a common test count for the key data generation circuit and the stream data generation circuit is describe, while it is possible to specify the test count differently between these circuits.

Description is given below of processing to perform the reliability test of the encryption/decryption unit 21.

The testing device 2 determines the number of counts to perform the test depending on required precision of the test. The count information for specifying the number of counts to perform the test may be stored in an arbitrary storage in the semiconductor memory 1 (such as the memory array 11, or a RAM, a ROM, or a register in the memory controller 12) in advance. The testing device 2 then receives the count information from the semiconductor memory 1 to determine the number of counts to perform the test.

The testing device 2 separately generates an expected value in each test of the key data generation circuit 31 and an expected value in each test of the stream data generation circuit 32. The testing device 2 is provided with the same test algorithm and common key as the encryption/decryption unit 21. The testing device 2 repeats the test algorithm for the number of counts to be performed as determined above, so as to generate an arithmetic value (CRC or hash value) as an expected value in each test.

The testing device 2 generates a test command (FIG. 9) containing a predetermined command ID and the above-obtained number of counts to perform the test and expected values (for the key data generation circuit 31 and for the stream data generation circuit 32) in each test, and sends the test command to the semiconductor memory 1.

The semiconductor memory 1 receives the test command and inputs the test command to the encryption/decryption unit 21. Since the test command is not encrypted, the received test command passes through the operational circuit 33 and is input to the extraction unit 41. The encryption/decryption unit 21 enters the test mode on receipt of an input of the test command, and switches the input terminal of the selector 60 from the memory array 11 for the normal mode to the comparison units 53 and 56 for the test mode.

The extraction unit 51 extracts the test count and the expected value from the test command, and inputs the test count as data D5 to the arithmetic units 54 and 57. The extraction unit 51 stores the expected value for the key data generation circuit 31 as data D6A in the storage 52 while storing the expected value for the stream data generation circuit 32 as data D6B in the storage 55. At this time, the input terminals of the selectors 58 and 59 are set to the common keys D1 and D2.

The key data generation circuit 31 generates key data D3 for the first test, on the basis of the common key D1 input from the selector 58.

The stream data generation circuit 32 generates stream data D4 for the first test, on the basis of the key data D3 input from the key data generation circuit 31.

The arithmetic unit 54 performs a predetermined arithmetic operation on the key data D3 input from the key data generation circuit 31 to calculate an arithmetic value in the key data generation circuit 31 in the first test. The arithmetic unit 57 performs a predetermined arithmetic operation on the stream data D4 input from the stream data generation circuit 32 to calculate an arithmetic value in the stream data generation circuit 32 in the first test.

The comparison unit 53 compares the arithmetic value (data D7A) input from the arithmetic unit 54 with the expected value (data D6A) input from the storage 52 to judge whether the arithmetic value is in agreement with the expected value in the first test of the key data generation circuit 31, and generates data D8A indicating a result of comparison. The comparison unit 56 compares the arithmetic value (data D7B) input from the arithmetic unit 57 with the expected value (data D6B) input from the storage 55 to judge whether the arithmetic value is in agreement with the expected value in the first test of the stream data generation circuit 32, and generates data D8B indicating a result of comparison.

The selector 58 switches the input terminal from the common key D1 to the key data generation circuit 31 in order to perform the second test of the key data generation circuit 31. The key data generation circuit 31 thereby receives an input of the key data D3 for the first test. The key data generation circuit 31 generates the key data D3 for the second test, using the key data D3 for the first test as a test pattern. In the third and onward tests, the input terminal of the selector 58 is similarly set to the key data generation circuit 31.

Similarly, the selector 59 switches the input terminal from the common key D2 to the stream data generation circuit 32 in order to perform the second test of the stream data generation circuit 32. The stream data generation circuit 32 thereby receives an input of the stream data D4 for the first test. The stream data generation circuit 32 generates the stream data D4 for the second test, using the stream data D4 for the first test as a test pattern. In the third and onward tests, the input terminal of the selector 59 is similarly set to the stream data generation circuit 32.

From this point onward, processing similar to the above is repeated for the number of test counts, and the data D8A and D8B indicating the result of comparison in each test is output from the comparison units 53 and 56.

The encryption/decryption unit 21 sends the data D8A and D8B for the specified number of test counts to the testing device 2 as a return value to the test command.

In the semiconductor memory 1 according to Embodiment 3, the self test unit 34 performs the reliability test of the key data generation circuit 31, on the basis of the key data D3 generated by the key data generation circuit 31, while performing the reliability test of the stream data generation circuit 32, on the basis of the stream data D4 generated by the stream data generation circuit 32. Performing the tests of the key data generation circuit 31 and the stream data generation circuit 32 separately achieves accurate identification as to whether a failure occurs in the key data generation circuit 31 or the stream data generation circuit 32.

In the semiconductor memory 1 according to Embodiment 3, the extraction unit 51 extracts a first expected value for the key data generation circuit 31 and a second expected value for the stream data generation circuit 32 from the test command. The storage 52 (first storage) stores the first expected value extracted by the extraction unit 51, while the storage 55 (second storage) stores the second expected value extracted by the extraction unit 51. The arithmetic unit 54 (first arithmetic circuit) performs a predetermined arithmetic operation on the key data D3 generated by the key data generation circuit 31 to output a first arithmetic value, while the arithmetic unit 57 (second arithmetic circuit) performs a predetermined arithmetic operation on the stream data D4 generated by the stream data generation circuit 32 to output a second arithmetic value. The comparison unit 53 (first comparison circuit) compares the first arithmetic value output from the arithmetic unit 54 with the first expected value stored in the storage 52, while the comparison unit 56 (second comparison circuit) compares the second arithmetic value output from the arithmetic unit 57 with the second expected value stored in the storage 55. The results of comparison by the comparison units 53 and 56 are sent to the testing device 2. Comparing the first expected value and the first arithmetic value by the comparison unit 53 in the semiconductor memory 1 achieves an appropriate check on the key data generation circuit 31 for a failure. Similarly, comparing the second expected value and the second arithmetic value by the comparison unit 56 in the semiconductor memory 1 achieves an appropriate check on the stream data generation circuit 32 for a failure. Since it is not necessary to send the first and the second arithmetic values from the semiconductor memory 1 to the testing device 2, the amount of communication data between these devices is effectively reduced.

In the semiconductor memory 1 according to Embodiment 3, the self test unit 34 inputs the key data D3 generated by the key data generation circuit 31 to the key data generation circuit 31, and causes the key data generation circuit 31 to generate subsequent key data D3, so as to perform the reliability test of the key data generation circuit 31 multiple times. Similarly, the self test unit 34 inputs the stream data D4 generated by the stream data generation circuit 32 to the stream data generation circuit 32, and causes the stream data generation circuit 32 to generate subsequent stream data D4, so as to perform the reliability test of the stream data generation circuit 32 multiple times. Performing the reliability test of the key data generation circuit 31 and the stream data generation circuit 32 multiple times improves the precision of the test. A test pattern is updated by inputting the key data D3 generated by the key data generation circuit 31 to the key data generation circuit 31 and inputting the stream data D4 generated by the stream data generation circuit 32 to the stream data generation circuit 32, which facilitates producing multiple test patterns by the encryption/decryption unit 21 itself.

In the semiconductor memory 1 according to Embodiment 3, the number of counts to perform the reliability test of the key data generation circuit 31 and the stream data generation circuit 32 is specified by means of a test command. Specifying the number of counts to perform the reliability test by the testing device 2 effectively optimizes the number of counts to perform the test depending on required precision of the test.

### Embodiment 4

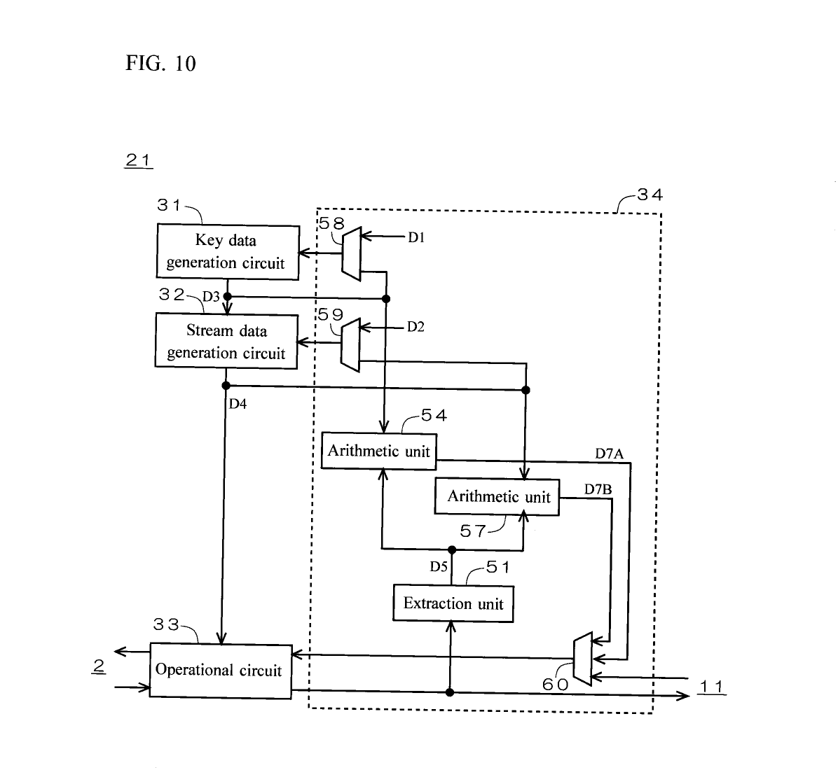

FIG. 10 is a diagram illustrating a configuration of the encryption/decryption unit 21 according to Embodiment 4 of the present disclosure. The storages 52 and 55 and the comparison units 53 and 56 are omitted from the circuit configuration illustrated in FIG. 8. The data structure of the test command in Embodiment 4 is the same as the structure in FIG. 7.

Description is given below of processing to perform the reliability test of the encryption/decryption unit 21, concentrating on differences from Embodiment 3 above.

The testing device 2 determines the number of counts to perform the test depending on required precision of the test.

The testing device 2 separately generates an expected value in each test of the key data generation circuit 31 and an expected value in each test of the stream data generation circuit 32.

The testing device 2 generates a test command (FIG. 7) containing a predetermined command ID and the above-obtained number of counts to perform the test, and sends the test command to the semiconductor memory 1. The testing device 2 stores the above-obtained expected value in each test in itself without sending the value to the semiconductor memory 1.

The semiconductor memory 1 receives the test command and inputs the test command to the encryption/decryption unit 21. The encryption/decryption unit 21 enters the test mode on receipt of an input of the test command, and switches the input terminal of the selector 60 from the memory array 11 for the normal mode to the arithmetic units 54 and 57 for the test mode.

The extraction unit 51 extracts the test count from the test command, and inputs the test count as data D5 to the arithmetic units 54 and 57. At this time, the input terminals of the selectors 58 and 59 are set to the common keys D1 and D2.

The key data generation circuit 31 generates key data D3 for the first test, on the basis of the common key D1 input from the selector 58.

The stream data generation circuit 32 generates stream data D4 for the first test, on the basis of the key data D3 input from the key data generation circuit 31.

The arithmetic unit 54 performs a predetermined arithmetic operation on the key data D3 input from the key data generation circuit 31 to calculate an arithmetic value in the key data generation circuit 31 in the first test. Similarly, the arithmetic unit 57 performs a predetermined arithmetic operation on the stream data D4 input from the stream data generation circuit 32 to calculate an arithmetic value in the stream data generation circuit 32 in the first test.

The selector 58 switches the input terminal from the common key D1 to the key data generation circuit 31 in order to perform the second test of the key data generation circuit 31. The key data generation circuit 31 thereby receives an input of the key data D3 for the first test. The key data generation circuit 31 generates the key data D3 for the second test, using the key data D3 for the first test as a test pattern. In the third and onward tests, the input terminal of the selector 58 is similarly set to the key data generation circuit 31.

Similarly, the selector 59 switches the input terminal from the common key D2 to the stream data generation circuit 32 in order to perform the second test of the stream data generation circuit 32. The stream data generation circuit 32 thereby receives an input of the stream data D4 for the first test. The stream data generation circuit 32 generates the stream data D4 for the second test, using the stream data D4 for the first test as a test pattern. In the third and onward tests, the input terminal of the selector 59 is similarly set to the stream data generation circuit 32.

From this point onward, processing similar to the above is repeated for the number of test counts, and the data D7A and D7B indicating the arithmetic value in each test is output from the arithmetic units 54 and 57.

The encryption/decryption unit 21 sends the data D7 for the specified number of test counts to the testing device 2 as a return value to the test command.

The testing device 2 compares the arithmetic value (data D7A and D7B) received from the semiconductor memory 1 with the expected value stored in itself for each test to judge whether the arithmetic value is in agreement with the expected value.

In the semiconductor memory 1 according to Embodiment 4, the arithmetic unit 54 (first arithmetic circuit) performs a predetermined arithmetic operation on the key data D3 generated by the key data generation circuit 31, while the arithmetic unit 57 (second arithmetic circuit) performs a predetermined arithmetic operation on the stream data D4 generated by the stream data generation circuit 32. The first arithmetic value (data D7A) output from the arithmetic unit 54 and the second arithmetic value (data D7B) output from the arithmetic unit 57 is sent to the testing device 2. Comparing the expected value and the first arithmetic value by the testing device 2 achieves an appropriate check on the key data generation circuit 31 for a failure. Similarly, comparing the expected value and the second arithmetic value by the testing device 2 achieves an appropriate check on the stream data generation circuit 32 for a failure. Since it is not necessary to provide the semiconductor memory 1 with the storages 52 and 55 and the comparison units 53 and 56, the configuration of the semiconductor memory 1 is effectively simplified.

While the invention has been described in detail, the foregoing description is in all aspects illustrative and not restrictive. It is understood that numerous other modifications and variations can be devised without departing from the scope of the invention.

What is claimed is:

1. A semiconductor device comprising:
a controller including a plurality of processing circuits,
the plurality of processing circuits including an encryption/decryption circuit configured to encrypt and decrypt a signal transmitted to and from the controller,
the encryption/decryption circuit including a self test circuit configured to perform a reliability test of the encryption/decryption circuit on receipt of a predetermined test command from an external device.

2. The semiconductor device according to claim 1,
the encryption/decryption circuit further including
a first data generation circuit configured to generate first data, and
a second data generation circuit configured to generate second data for encryption and decryption based on the first data generated by the first data generation circuit,
the self test circuit being configured to perform a reliability test of the first data generation circuit and the second data generation circuit based on the second data generated by the second data generation circuit.

3. The semiconductor device according to claim 2,
the self test circuit including
an extraction circuit configured to extract an expected value from the test command;
a storage for storing the expected value extracted by the extraction circuit;
an arithmetic circuit configured to perform a predetermined arithmetic operation on the second data generated by the second data generation circuit and output an arithmetic value; and
a comparison circuit configured to compare the arithmetic value output from the arithmetic circuit with the expected value stored in the storage,
the self test circuit being configured to send a result of comparison by the comparison circuit to the external device.

4. The semiconductor device according to claim 2,
the self test circuit including an arithmetic circuit configured to perform a predetermined arithmetic operation on the second data generated by the second data generation circuit,
the self test circuit being configured to send an arithmetic value output from the arithmetic circuit to the external device.

5. The semiconductor device according to claim 2, wherein
the self test circuit is configured to input the second data generated by the second data generation circuit to the first data generation circuit to cause the first data generation circuit and the second data generation circuit to generate subsequent first data and subsequent second data respectively so as to perform the reliability test of the first data generation circuit and the second data generation circuit a plurality of times.

6. The semiconductor device according to claim 5, wherein
a number of counts to perform the reliability test of the first data generation circuit and the second data generation circuit is specified by the test command.

7. The semiconductor device according to claim 1,
the encryption/decryption circuit further including
a first data generation circuit configured to generate first data, and
a second data generation circuit configured to generate second data for encryption and decryption based on the first data generated by the first data generation circuit,
the self test circuit being configured to
perform the reliability test of the first data generation circuit based on the first data generated by the first data generation circuit, and
perform the reliability test of the second data generation circuit based on the second data generated by the second data generation circuit.

8. The semiconductor device according to claim 7,
the self test circuit including
an extraction circuit configured to extract a first expected value and a second expected value from the test command;
a first storage for storing the first expected value extracted by the extraction circuit;
a second storage for storing the second expected value extracted by the extraction circuit;
a first arithmetic circuit configured to perform a predetermined arithmetic operation on the first data generated by the first data generation circuit and output a first arithmetic value;
a first comparison circuit configured to compare the first arithmetic value output from the first arithmetic circuit with the first expected value stored in the first storage;
a second arithmetic circuit configured to perform a predetermined arithmetic operation on the second data generated by the second data generation circuit and output a second arithmetic value, and
a second comparison circuit configured to compare the second arithmetic value output from the second arithmetic circuit with the second expected value stored in the second storage,
the self test circuit being configured to send a result of comparison by the first comparison circuit and a result of comparison by the second comparison circuit to the external device.

9. The semiconductor device according to claim 7,
the self test circuit including
a first arithmetic circuit configured to perform a predetermined arithmetic operation on the first data generated by the first data generation circuit, and
a second arithmetic circuit configured to perform a predetermined arithmetic operation on the second data generated by the second data generation circuit,
the self test circuit being configured to send the first arithmetic value output from the first arithmetic circuit and the second arithmetic value output from the second arithmetic circuit to the external device.

10. The semiconductor device according to claim 7, wherein
the self test circuit is configured to
input the first data generated by the first data generation circuit to the first data generation circuit to cause the first data generation circuit to generate subsequent first data so as to perform the reliability test of the first data generation circuit a plurality of times, and
input the second data generated by the second data generation circuit to the second data generation circuit to cause the second data generation circuit to generate subsequent second data so as to perform the reliability test of the second data generation circuit a plurality of times.

11. The semiconductor device according to claim 10, wherein
a number of counts to perform the reliability test of the first data generation circuit and the second data generation circuit is specified by the test command.

12. A method for testing reliability of a semiconductor device,
the semiconductor device including a plurality of processing circuits including an encryption/decryption circuit, the method comprising:
performing a reliability test of the encryption/decryption circuit by a self test; and
performing a reliability test of the plurality of processing circuits except for the encryption/decryption circuit by a scan test.
